(19) United States
(12) Patent Application Publication
(10) Pub. No.: US 2013/0073475 A1
(43) Pub. Date: Mar. 21, 2013

(54) System and Method for Creating, Contributing to and Measuring Progress Towards a Common Objective

(71) Applicants: James Kinkaid, Ottawa (CA); Hana Abaza, Ottawa (CA)

(72) Inventors: James Kinkaid, Ottawa (CA); Hana Abaza, Ottawa (CA)

(21) Appl. No.: 13/640,570

(22) PCT Filed: Apr. 15, 2011
(86) PCT No.: PCT/CA2011/000418

§ 371 Date: Nov. 20, 2012

Related U.S. Application Data
(60) Provisional application No. 61/325,215, filed on Apr. 16, 2010.

(51) Int. Cl. G06Q 99/00

(52) U.S. Cl. 705/319

(57) ABSTRACT

The invention provides users with a centralized location to visually represent a objective or common objective and invite members of a defined community to contribute towards achieving the objective. The invention monitors progress as community members begin to contribute towards the objective, creating a clear and measurable method of determining advancement towards achieving the objective. This system can be used in multiple contexts, but is particularly well suited for scenarios such as gift or wedding registries where “group give” functionality becomes necessary. The system provides the ability to create a visual representation of a product such as gift, segment the product, and allow for multiple persons (i.e. the community of wedding guests) to simultaneously monitor progress and contribute towards the objective.

### CROSS REFERENCE TO RELATED APPLICATIONS

This application claims the benefit of U.S. Provisional Patent Application No. 61/325,215 entitled “System and method for monitoring and measuring community progress towards a common objective” filed on Apr. 16, 2010.

### FEDERAL RESEARCH

N/A

### FIELD OF THE INVENTION

This invention relates to data processing for financial, business practice, management or cost price determination applications where there is a computerized arrangement for the management of interaction between individuals or entities who are connected by social networking, and specifically, for a system and method for creating, contributing to and measuring progress towards a common objective.

### BACKGROUND OF THE INVENTION

With the increased socialization through online networks and multiple connections between individuals and groups across the globe it is now possible to mobilize and engage a community or pre-defined group of people to achieve a common objective. This has become of increasing commercial importance. As such, a way create, contribute to, measure and track community progress towards achieving a particular objective has become necessary.

An Internet based system for measuring and monitoring community progress towards achieving a particular objective can be used in multiple contexts including situations where group giving or group contributions or collaborations are integral components of achieving the objective. This includes, for example, charitable donations, gift registries for all occasions such as birthdays, Christmas, anniversaries and weddings. The same would apply to community collaboration in the creation of a commercial product in relation to, for example, the development of a computer software program.

Presently, there is a lack of and a need for, an effective system and method for creating a community objective, allowing members of the community to contribute to the community objective and providing a common view of progress towards a common objective. There is also an inability to link e-commerce to social networking.

### SUMMARY OF THE INVENTION

The system of the present invention provides users with a centralized location to visually present a common objective and invite members of a defined community to contribute towards achieving the objective through social networking and e-commerce applications. The invention monitors group progress as community members begin to contribute towards the common objective thereby creating a clear and measurable method of determining advancement towards achieving the objective. This system can be used in multiple contexts, but is particularly well suited for cash scenarios such as gifts and wedding registries where “group give” functionality becomes necessary due to the expensive nature of gifts. The system provides the ability to create a visual representation of a product such as gift, segment the product into affordable pieces for cash contributions or “purchases” by one or more members of the community using social networking and e-commerce. The system allows for multiple persons (i.e. the community of wedding guests) to simultaneously monitor community progress towards achieving a common objective and contribute towards the common objective of obtaining sufficient cash for the wedding couple to purchase all of the gifts on the gift registry.

Another example of a well suited scenario includes the collection of charitable cash donations towards a defined cash objective. The system allows for “group give” by a community towards a visual representation of event, person, or object. The system, as an example, allows a fundraiser to collect cash donations towards a visual representation of a sponsored marathon runner's objective to finish a race, each “step” or “mile” of the race.

In the specific context of wedding registries, the invention in combination with an online environment that facilitates the storage of user information, a gift registry database and systems to notify and share the registry information will preferably provide the following features:
A centralized online gift registry that provides registration of information about a user and allows access to the registry by a group of potential gift giver users.
The ability to create new registry items or customize existing items by modifying/adding a description, choosing a price for the item, and uploading a picture of the item.
A distinct advantage of this system is that a user can segment a gift into multiple pieces, allowing the user to engage multiple gift givers “guests” on one registry gift item. With more people able to chip in, expensive items become more accessible to the couple.
The user can register for non-traditional gift items (i.e. down payment on a house) that may also be out of the price point of a single guests.
The user can add a visual representation of virtually anything, making the scope of possible wedding gifts limitless as opposed to traditional options where the user is limited to a single merchant retailer.
The visual representation provides clear and measurable action steps that guests can take to fulfill the objective and allows the guests to see what they are contributing to.
The user can easily track how much of the gift has been purchased and monitor whether they need to create additional gift items.
System for monitoring progress allows the user to evaluate community response and apply the knowledge as needed.
The system permits the use of e-commerce applications over social networks to make contributions to a central registry.

### BRIEF DESCRIPTION OF DRAWINGS

FIG. 1 is a schematic depiction of one embodiment of the system of the invention.

FIG. 2 is a process flow sheet for using one embodiment of the invention.

FIG. 3 is a process flow sheet for customizing objectives in one embodiment of the invention.

FIG. 4 is a process flow sheet for notifying community members.

FIG. 5 is a flow sheet depicting the payment process.

FIG. 6 is a screen shot for creating a new wedding gift registry.

FIG. 7 is a screen shot for selecting a gift.

FIG. 8 is a screen shot for segmenting a gift.

FIG. 9 is a screen shot for prioritizing a gift.

FIG. 10 is a screen shot for customizing a gift.

FIG. 11 is a screen shot for view the gift registry being built.

FIG. 12 is a screen shot of uploading community member e-mails to the system.

FIG. 13 is a sample message generated by the system to the user.

FIG. 14 is a sample message generated by the system to the guest.

FIG. 15 is a depiction of the share registry for the guest in one embodiment of the invention.

FIG. 16 is a screen shot showing a gift selection window for the guest.

FIG. 17 is a screen shot showing the gifts selected by the guest for purchase.

FIG. 18 is a screen shot depicting a check out window.

FIG. 19 is a screen shot depicting a charitable event window wherein the contributions have been segmented.

### DETAILED DESCRIPTION

The System

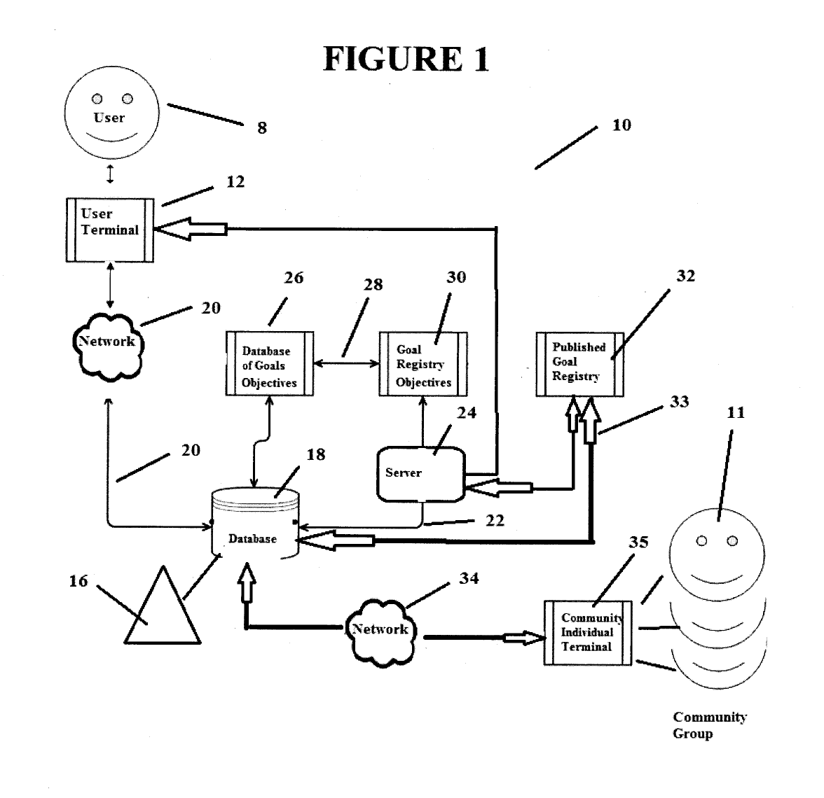

Referring to FIG. 1, there is shown a schematic diagram of one embodiment of the system of the invention 10. The system shown in FIG. 1 is a generic system and so modifications are possible to suit applications of the system as further explained below.

The system 10 comprises a user terminal 12 which may be a home computer or a portable computing device. The terminal 12 is used by a subscriber to the system or “user” 8. The user 8 is an individual or group of individuals or an organization that wishes to invite a community of individuals 11 to participate in an “event”. As further detailed below, the event can be a wedding or a charity fund raising drive or a sports event sponsorship. The user 8 may be a wedding organizer. The community 11 may he members of a known list of wedding invitees.

The user 8 accesses the system microprocessor 16 and database 18 over a communications network 20 which may be one of the Internet and a cellular telephone network. The microprocessor 16 will respond to the access request by requesting 22 that the system server 24 display the system homepage to the user on the user terminal 12. The user 8 will register on the system homepage and provide personal information as well as information about the event.

The system will prompt the user to continue to input information about the event such as event date, location and the community objectives of the event. The community objectives are selected by the user from a list of community objectives 26 stored on the database 18. The user selects a community objective and transfers the objective 28 onto a objective registry 30. The registry is stored on the database. Once the user is satisfied that the registry is complete, the user can instruct 14 the system 10 to publish the registry 32 for access 33 by the individuals of the community group through a social network 34 and terminal 35 which may be a computer terminal, a cellular phone or other personal communication device. The individual can then select and purchase a objective as described below using an e-commerce application. Therefore the system is able to link e-commerce applications to social networks.

The Method

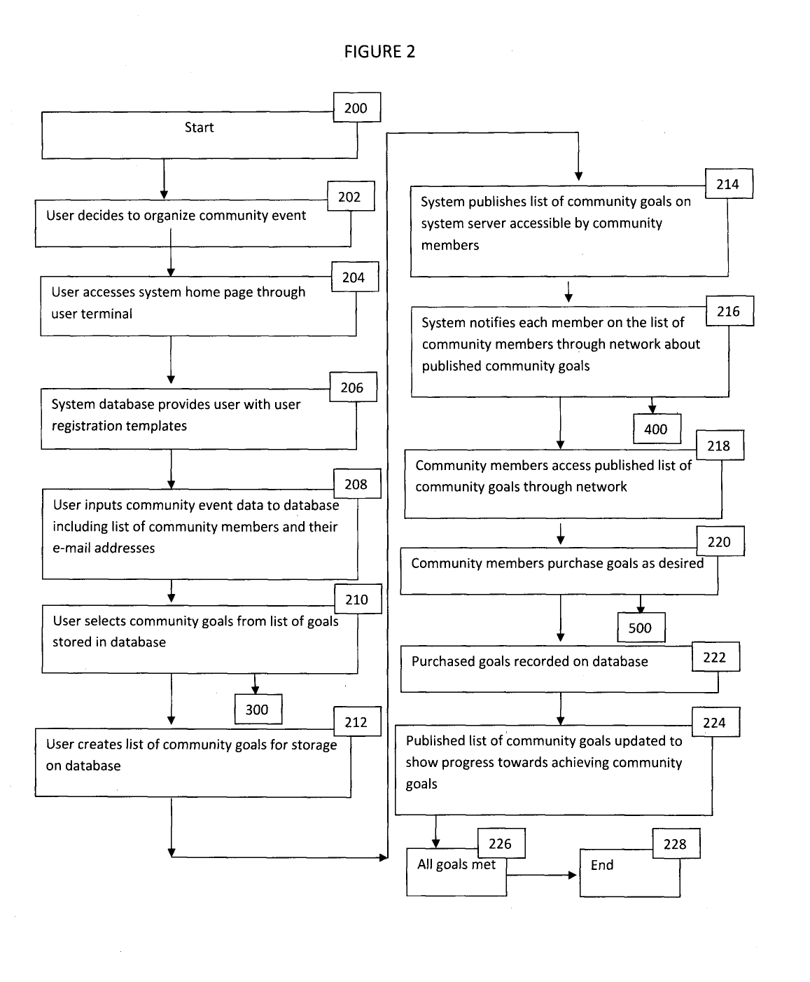

Referring to FIG. 2, there is shown a flowchart depicting the process by which the community objectives are selected and published. From the beginning 200 the user decides that a community event should be organized 202. The event may be a fund raising event to raise cash for a charity or a wedding gift registry to raise cash for an engaged couple. The next step 204 is for the user to access the system home page using the user terminal. As shown in FIG. 1, the user 8 has access to terminal 12 for accessing the system home page over the network 20. In the next step 206 the system provides the user with a series of templates so that the user can input data about him/herself or the organization such as name, e-mail and date of event. Referring to FIG. 1, these templates are stored on the database 18 operated by microprocessor 16. The microprocessor orders the database to send the templates to the system server 24 and then to the user terminal 12. The database received the user input to the templates and stores them. The user will select his or her own password and a unique URL to display the completed registry. In the next step 208 the user will input the community event data including a list of community members participating in the event and their respective e-mail addresses. In the next step 210 the user is provided a list of objectives from which to select objectives to be met by the community. Referring to FIG. 1, this list is a database 26 accessible by the user 8. In one example, the database may contain a selection of suitable wedding gifts that the system has prepared for the user. The user is also able to upload his or her own objectives (gifts, objectives etc) into the database for display on the registry.

In the next step 212 the user creates or builds a suitable list of community objectives. This is referred to as the objective registry in FIG. 1, Item 30. In the next step 214, when the user has completed the objective registry, the user instructs the system to publish the list of community objectives on the system server. In the next step 216 the system notifies each member of the community group over a computer networking system such as e-mail.

In the next step 218 the community members can take the necessary actions to achieve community objectives by accessing the published objective registry through a social networking system such as TWITTER or FACEBOOK. In step 220 the community members select and purchase objectives as desired and the objectives are paid for through an e-commerce payment process using the social networking system. Therefore, this invention links social networking and e-commerce applications. Once an objective is purchased, it is necessary at step 222 to record the purchased objectives on the database so that the system can update the published registry as to which objectives have been purchased and which objectives are still available. This is shown as step 224. In this way the progress of achieving the community objectives can be monitored. Once all objectives have been met in step 226 the objectives have been achieved and the process can terminate at 228.

Revenue is generated by the system by the application of a fee paid for by the community members. The fee is a percentage of the contribution. In another embodiment of the invention, the user may pay a subscription fee to the system. In yet another embodiment of the invention the system will carry advertising for a fee that will negate the user or community member having to pay a fee.

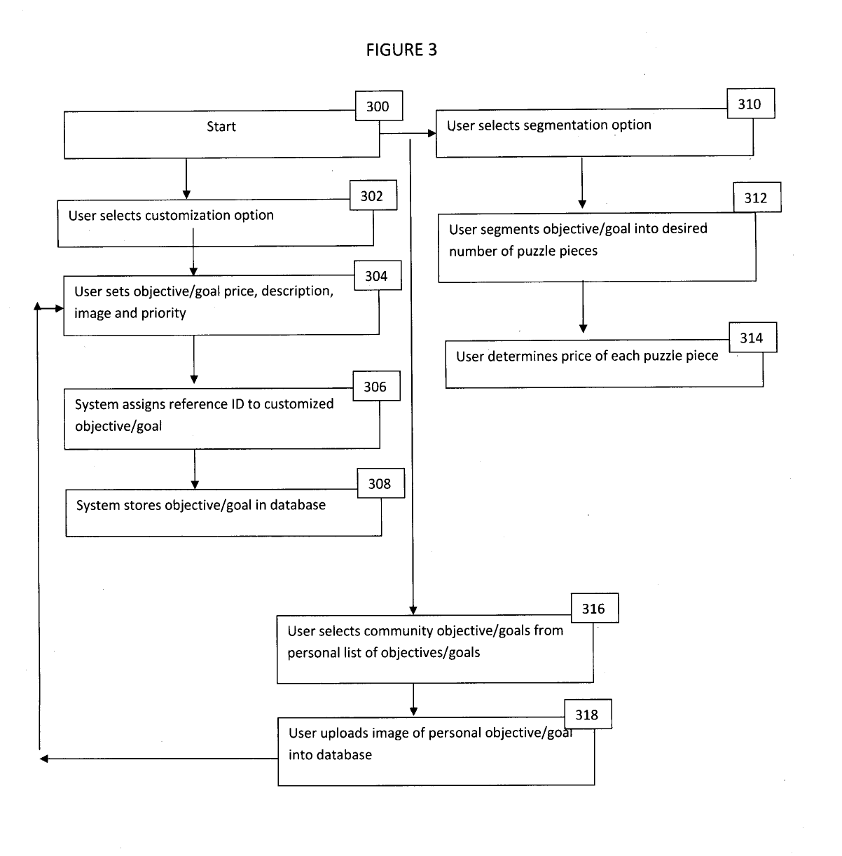

Referring to FIG. 2 and step 210, there is an optional step that the user can take at 300. Referring to FIG. 3, the user is presented with a customization option at step 302. At step 304 this permits the user to determine the cash value or price of the objective, draft a description of the objective, select an image of the objective and prioritize the objective with respect to other objectives selected. One advantage of the prioritization step is that the user is able to modify the priority of the objective as a way of ensuring the objective is met. For example, if the initial prioritization of the objective was low, and no community members are making a contribution to that objective, the user can raise the priority of the objective to ensure that it receives a contribution. This is information that will be presented to community members on the objective registry to provide a wider range of options to the community members. Once a objective has been customized, at step 306 the system will assign a reference identification number to the objective and store it in the database 308. A further option presented to the user is a segmentation option in step 310. For example, if the cash value of a single objective is too large for a single community member, the user can segment the objective into smaller pieces call puzzle pieces. These puzzle pieces can be bought singly or as a group at a much lower cost per piece over the entire object. At step 312 the user can select a suitable number of pieces to assign to particular object. This information is stored in the database. At step 316, if the user does not find a suitable objective listed on the database of objectives stored on the system database, the user can upload a personal objective. The system permits uploading of a photograph at step 318. Then the normal process from step 304 is followed to identify and possible segment the objective.

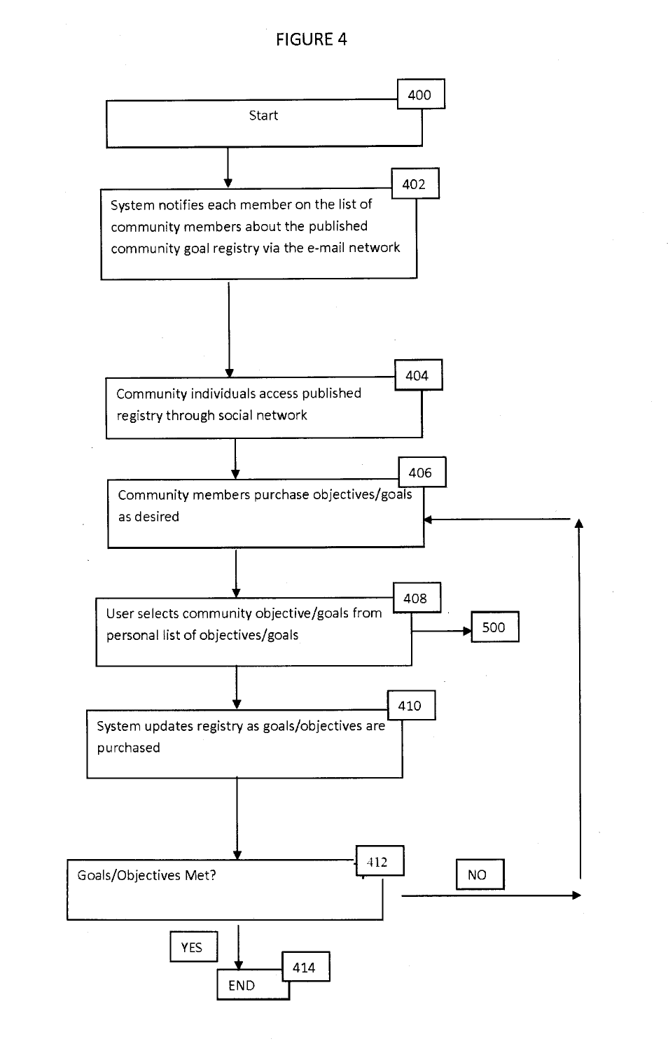

Referring to FIG. 2 and step 216, the system will notify each member of the community using a process described in FIG. 4. Commencing at 400 the system is directed to notify each community member 402 using the e-mails provided to the database by the user in step 208 over a computer network such as the Internet. At step 404, the members of the community access the objective registry using the social network such as TWITTER, BLOG or FACEBOOK. At step 406 the community members may select any objective on the registry and purchase that objective for a predetermined cash value in step 408. In step 410 the system will update the database and the objective registry when a purchase of a objective takes place. This permits the user and the community members to monitor the progress towards achieving the objectives for the event and modify priorities as required. If the objectives are met in step 412 the registry can terminate. If the objectives are not met then the system continues to display the registry until all objectives are purchased continuing at step 406.

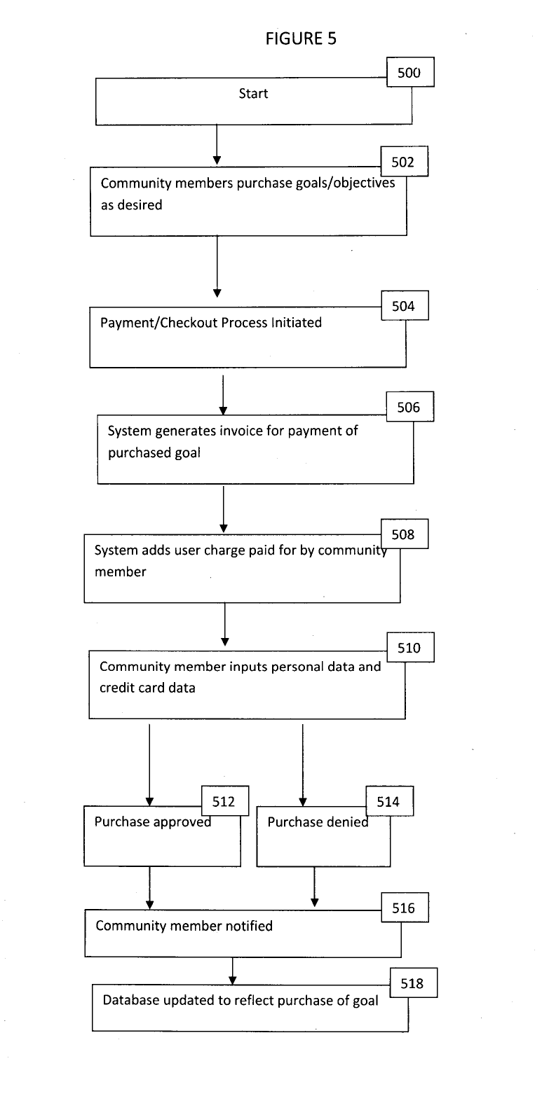

Referring to FIG. 2 item 220 and FIG. 4 item 408, once the user has selected a gift for purchase over the social network a purchasing process is invoked using an e-commerce application. Referring to FIG. 5, and commencing at 500, in step 502, the community member has indicated to the system that he or she wishes to purchase a particular objective. Once the purchase is indicated, the system will take the community member to a payment window at step 504. The system will generate an invoice at step 506 showing the cash value of the objective purchased. At step 508 the system will levy the system fee on the cash value of the objective. At step 510 the community member will input payment data such as credit card data into the data fields provided by the system. The purchase will either be accepted at step 510 if the credit card is accepted or denied at step 512 if the credit card is denied. Either way, the community member will be notified of the outcome at step 514. At step 518 the database will be updated to reflect any purchased objective.

Application #1

This invention involves the creation, monitoring and tracking of community progress towards achieving a particular common objective. The invention is particularly well suited for use in any context in which group contributions are an integral part to meeting a common objective. This may include, but is not limited to, charitable donations and gift registries for all occasions including birthday, Christmas, anniversary and weddings.

The system and method of the invention can be easily adapted to a wedding situation where a user wishes to create an on-line wedding registry of desired gifts. The purchase of gifts on the registry of gifts becomes the objective. The user may be the bride and groom or a friend of the bride and groom. The list of invitees that they wish to have participate in the wedding are the members of the community of interest that will make the contributions to achieve the objective.

The advantages of this system and method are very clear. Previously, the wedding guests who wished to purchase wedding gifts for the wedding couple would physically have to shop, purchase and wrap a gift and then present it to the wedding party. Alternatively, and in a typical fashion, the user may have registered at the bridal department of a large department store and created a wedding registry of gifts. Often, the wedding couple would not have total control over the type of gifts they received. The guests would then be notified, usually by mail or by telephone, of the fact that the user has established a wedding gift registry with a large department store. The guests would then have to visit the store, make an inquiry at the wedding gift registry desk within the department store and select a gift for the user.

The present invention eliminates the cumbersome need for guests to actually purchase gifts or visit department stores by linking e-commerce with social networking. The user will establish desired objectives in the field of gifts and the guests will contribute to those objectives by cash payments through the gift registry e-commerce system. The gift registry is a cash registry and the donations by the guests to the wedding party user are in cash. No gifts are actually purchased by the guests and carried to the wedding.

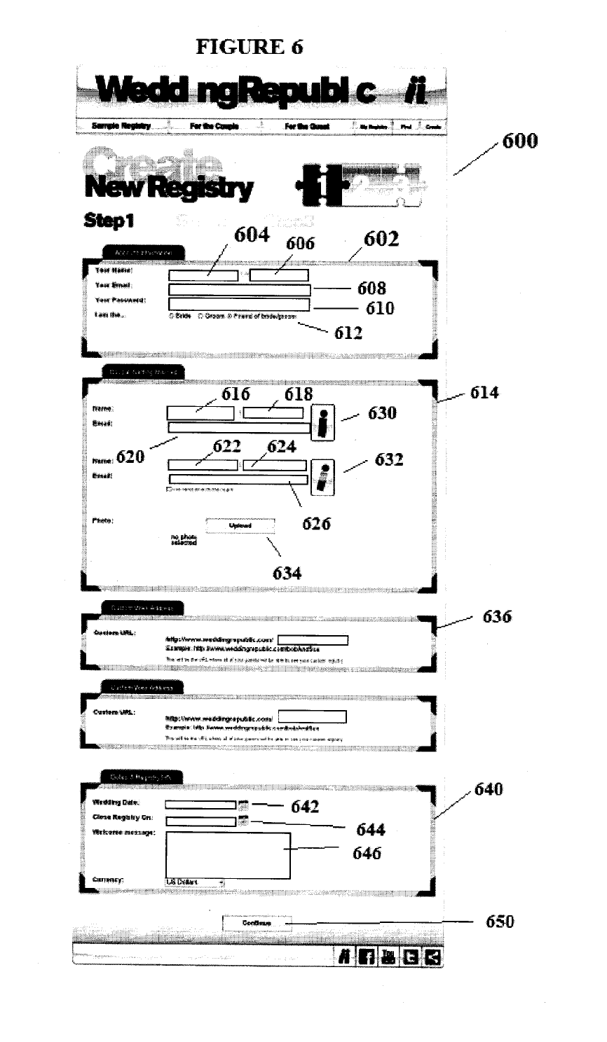

Referring to FIG. 6 there is shown a screen shot of a system template of one embodiment of the invention. This screen shot is meant to be exemplary only. FIG. 6 comprises a registration window 600 [See FIG. 2, Step 206]. The user will input account information into the data fields in window 602 comprising the user's first name 604 and the user's last name 606. The user will input an e-mail address in data field 608 and then select a password 610 which the user will use to securely access the system. The user will identify him or herself as one of the bride, groom or friend of the bride or groom in data field 612.

In window 614 information about the couple getting married is entered. The first name 616, last name 618 and e-mail address 620 of the bride/groom are inputted into the data fields. Similarly, the first name 622, last name 624 and e-mail address 626 of the other bride/groom are inputted into the data fields. A photo of the bride 630 and groom 632 can also be loaded into the system at 634 and then displayed.

In window 640 the user will input the date of the wedding 642 and the user will indicate the date when the gift registry should be closed 644. The user can create a message in field 646 which will be a welcoming message to the guests who wish to purchase gifts. The user will also indicate whether the gift registry is to be priced in a particular currency such as US dollars 648.

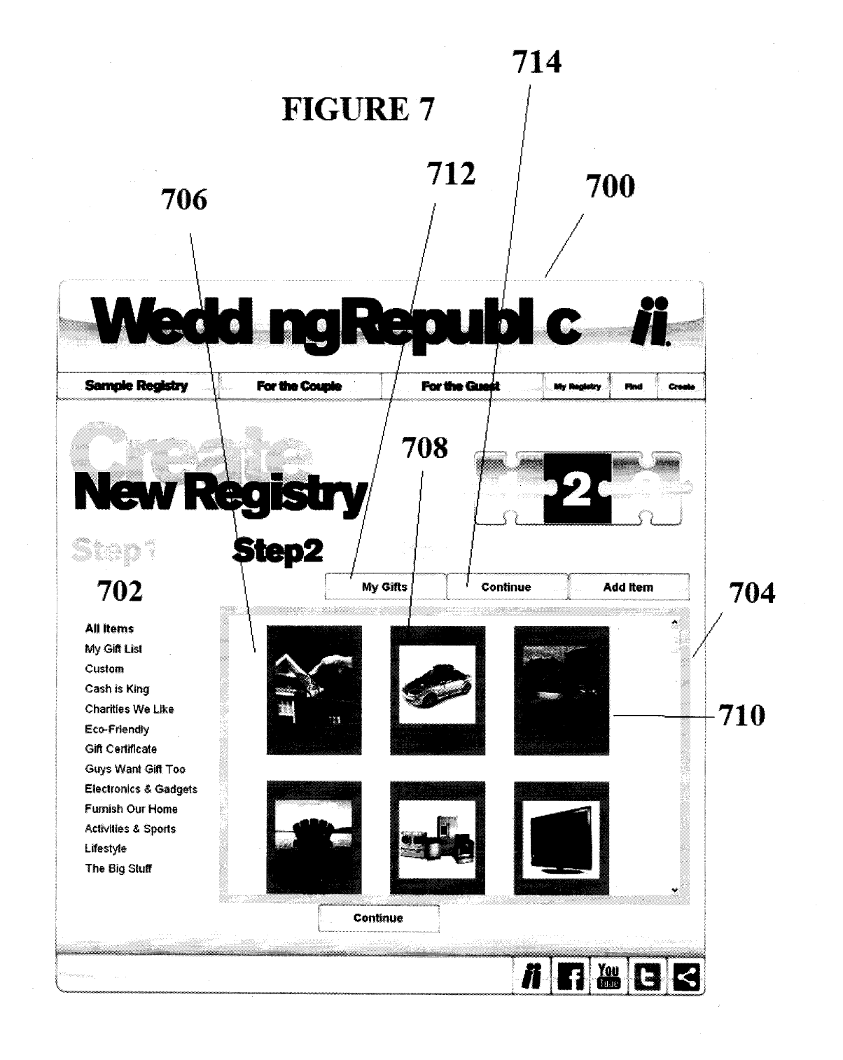

Once this data has been entered into window 600, the user will click button 650 and be taken to the create a new gift registry page on example of which is shown in FIG. 7 window 700.

The gift items are pre-programmed into the system database and categorized as shown in the list of categories 702 to the left of the gift selection window 704. Each gift available to the user is depicted pictorially. For example, a house 706, a car 708 and a backyard pool 710.

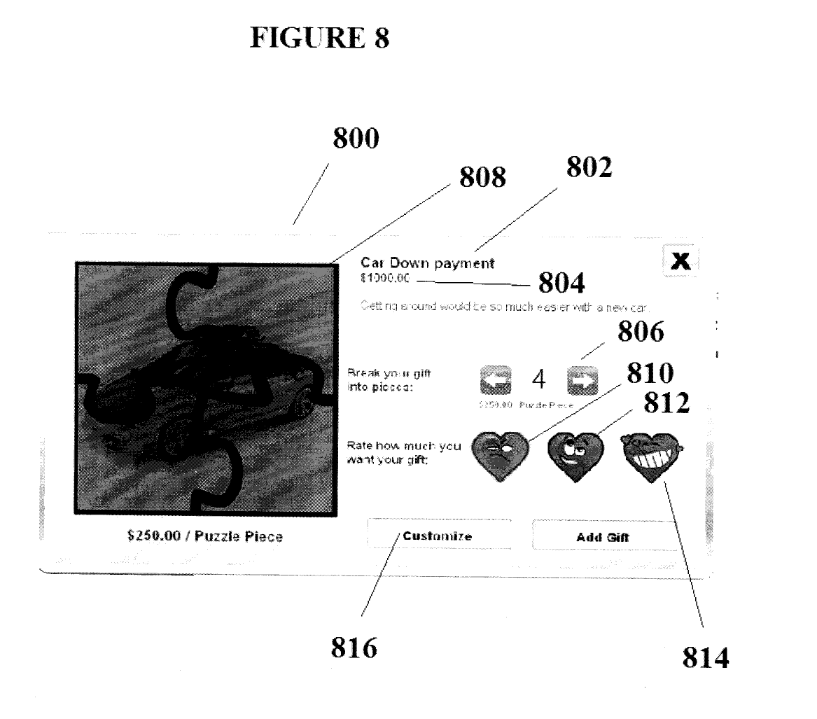

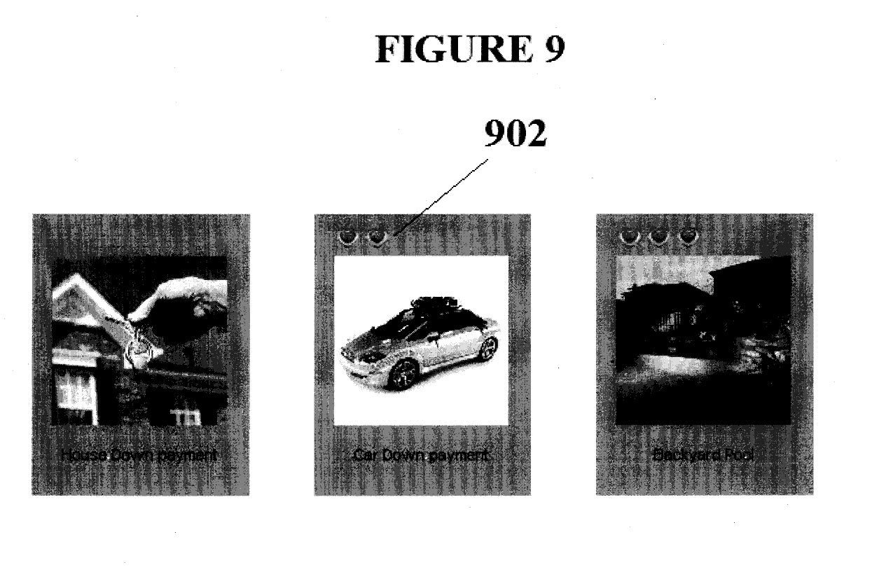

The user can create a gift list by clicking on one of the gifts. For example, if the user wishes to select the car pictorial 708, clicking on the car pictorial 708 will take the user to FIG. 8 and window 800. In window 800 the gift is described as a “car down payment” 802 and a value 804 to the car down payment is assigned in the amount of $1000. Since the amount of the car down payment may be seen to be very large to the guests it may make it difficult for guests to purchase this particular gift. Therefore, at 806 the user has an option of segmenting the gift into small pieces or “puzzle pieces” as shown in the window 808. By selecting four (4) pieces the purchase price for each piece of the puzzle becomes $250 which guests may find more affordable. Alternatively, the user could select 10 pieces at $25 each. Another feature of the invention is shown at items 810, 812 and 814. The user has the ability to prioritize each selected gift by clicking on one of the heart icons shown. Icon 810 is a comparatively desirability, icon 812 is a medium desirability and icon 814 is a high desirability. Once the desirability of the object has been selected, the item will appear on the gift registry shown on FIG. 9 with a priority label in the form of hearts 902. The more hearts mean that the user desires the guests to purchase that item above lesser priority items.

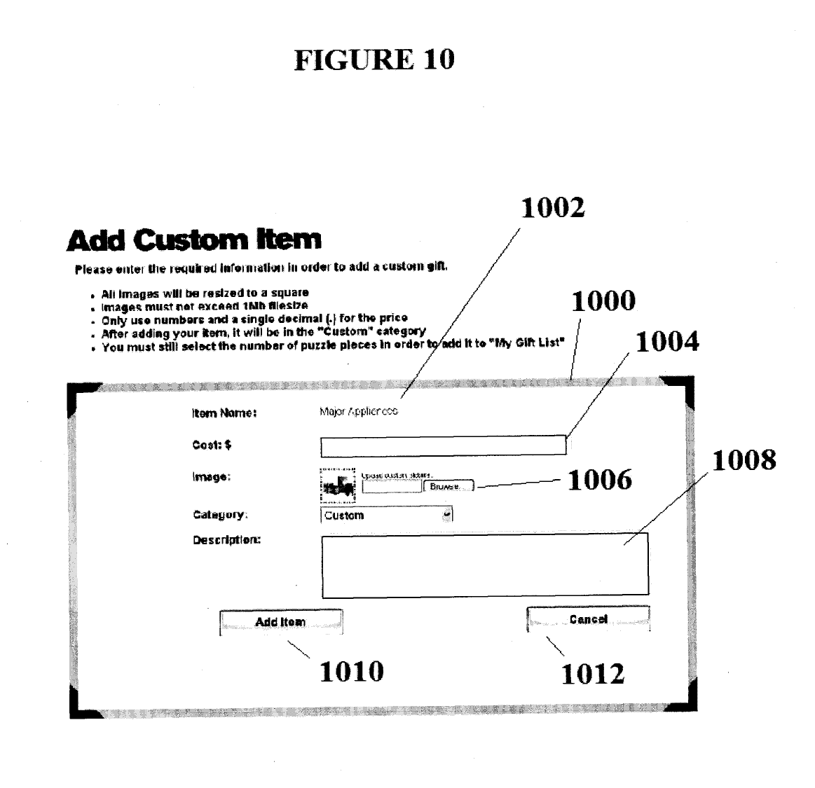

Returning to FIG. 8, clicking button 816 permits the gift item to be customized. The user is taken to FIG. 10 and window 1000. The name of the gift item is, for an example, “major appliances” 1002. The cost of the gift at 1002 can be modified to increase it or decrease the amount shown. A photo 1006 can be uploaded of a particular appliance that the user desires. A message can be added in text window 1008. When satisfied the user will click the ADD ITEM button 1010 and be returned to FIG. 8 window 800. The user then clicks on the ADD GIFT button and the gift is added to the gift registry. The user is then returned to FIG. 7 window 700 where the user can select another gift and follow the same process noted above. In this manner the user is able to build a gift registry by repeatedly adding items displayed in window 704 to the gift registry.

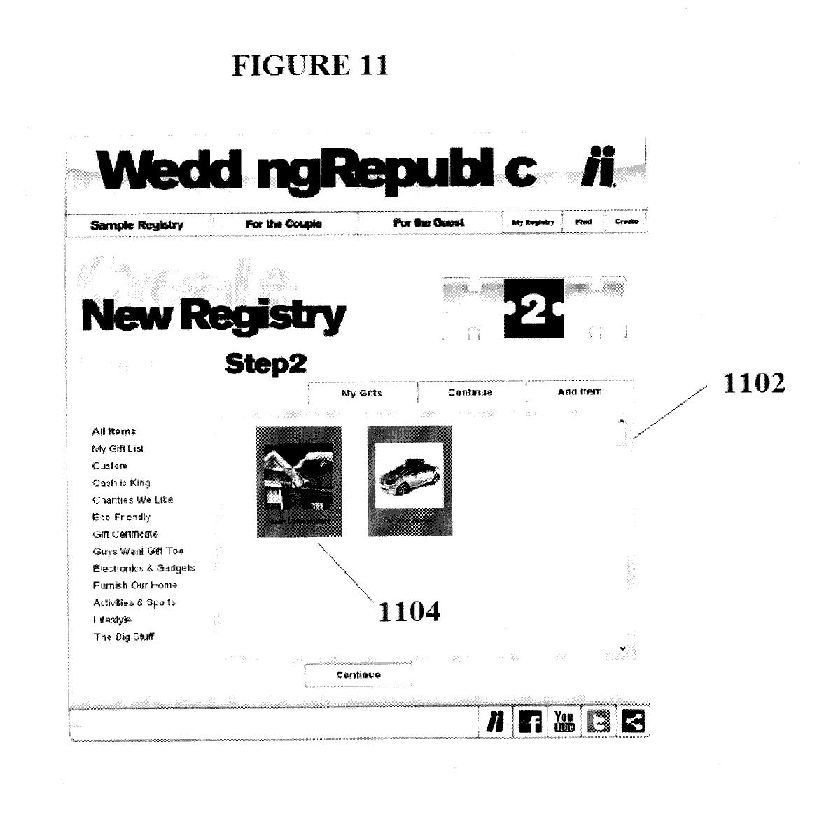

Referring to FIG. 7 and button 712 the user can click on MY GIFTS and view the gift registry as it exists at any time during the registry build process. This is illustrated in FIG. 11 NEW REGISTRY, window 1102 where the house down payment pictorial 1104 is shown as one example. A repeated selection of gifts will build the gift registry to a desired level.

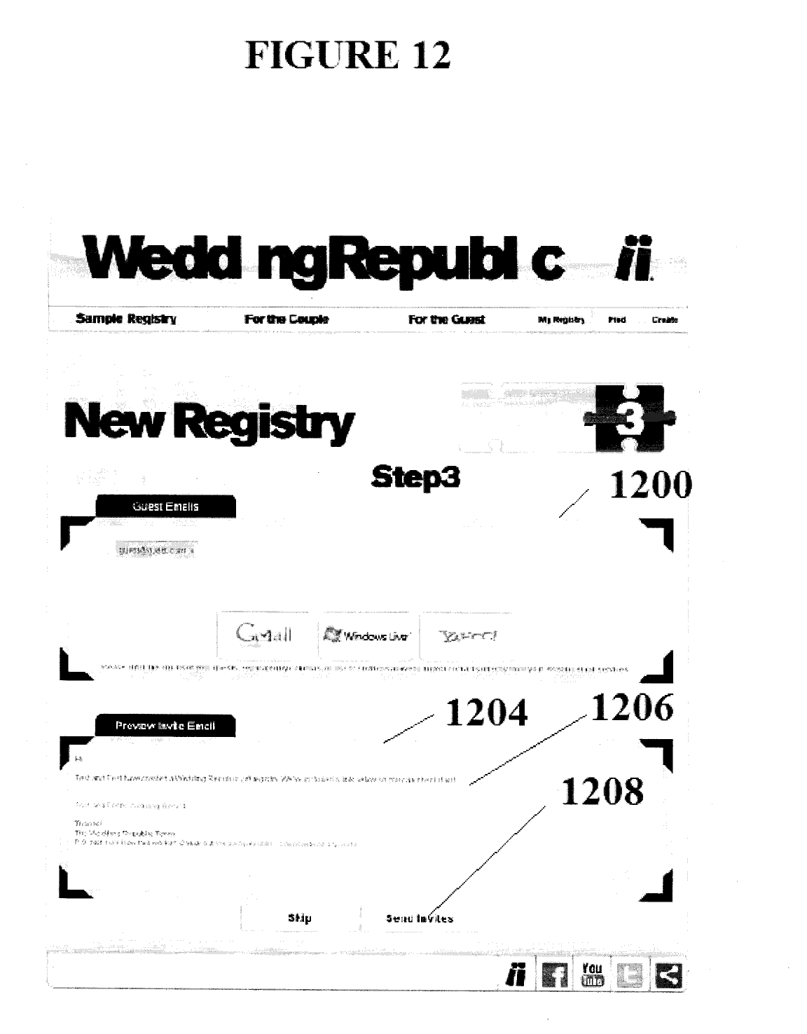

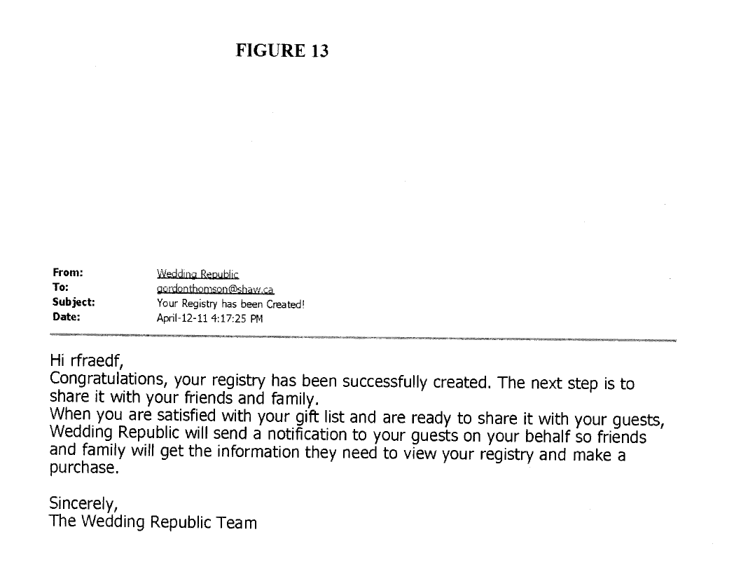

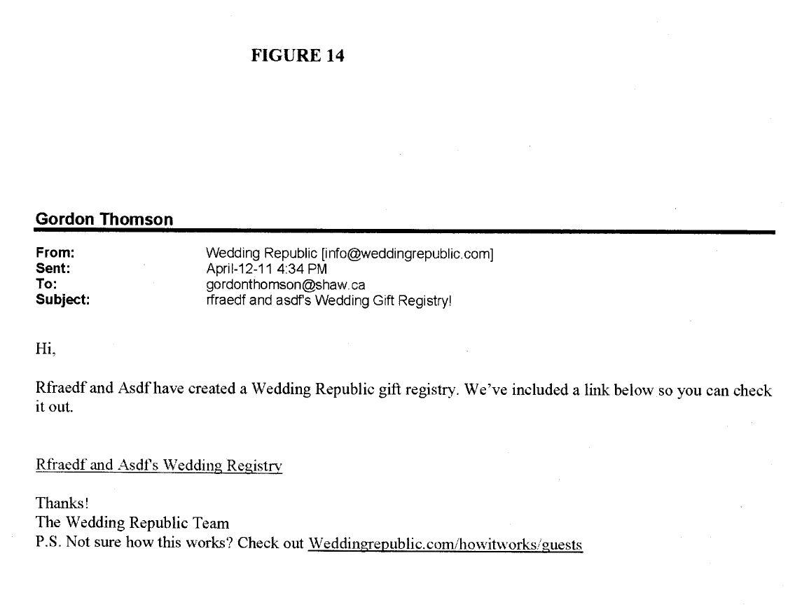

Once the user is satisfied that the gift list is complete, the user will click on button 712 CONTINUE and will be taken to FIG. 12, window 1200. Within window 1200 the user will place all of the e-mails of the guests invited to the wedding. If the user has a list of e-mail contacts stored in another application such as WINDOWS LIVE 1202 then clicking on the WINDOWS LIVE button will allow the user to import that list to window 1200. At window 1204 the user is able to input a message 1206 that each guest will see when being notified of the registry. The user then clicks on the SEND INVITES button 1208 and notification of the gift registry is sent to each addressee. Each addressee will receive a message like the one shown in FIG. 14. The user will receive a message like the one shown in FIG. 13.

Once the gift registry is finalized, the system will publish the gift registry using a suitable template on a website that a guest can access. Once the guest is notified that the registry exists, the guest is invited to visit the registry via the unique URL assigned by the user. From the guests' perspective, the gift registry becomes a share registry.

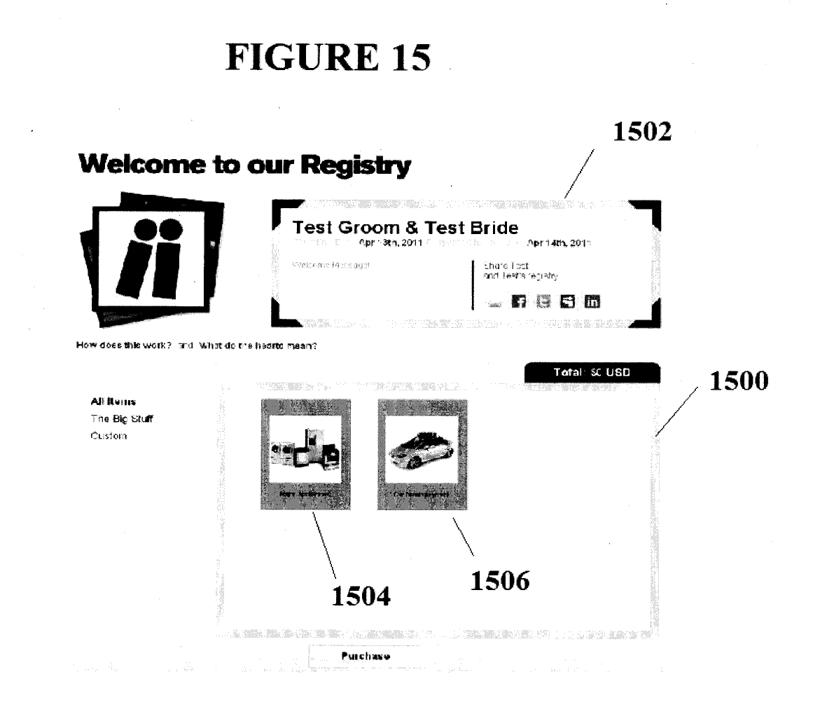

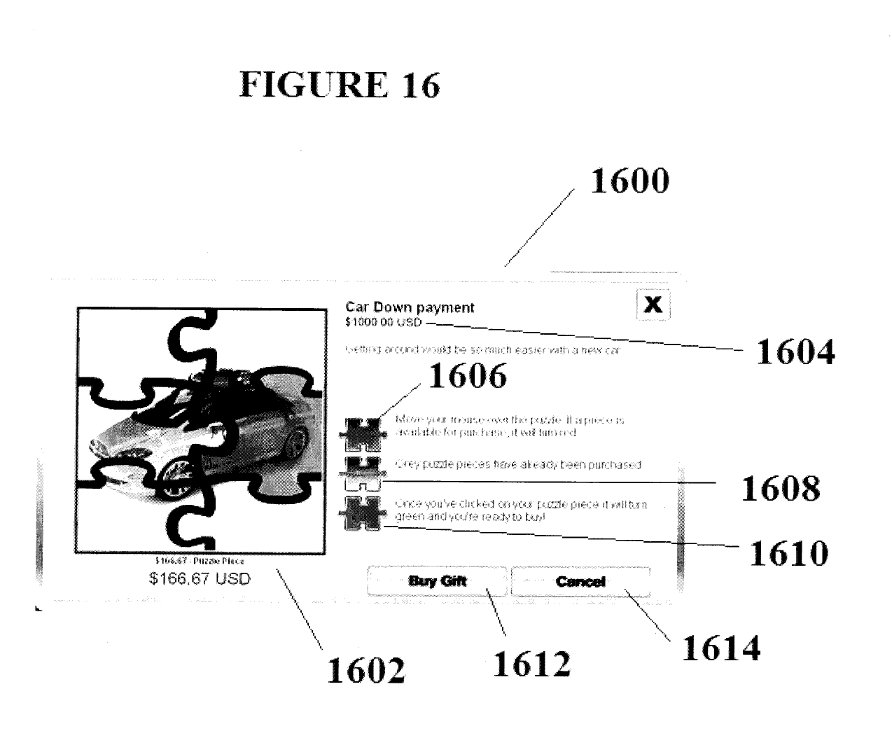

Referring now to FIG. 15, and the process for the guest to purchase a gift. FIG. 15 illustrates the window 1500 that the guest will view upon entering the share registry. Window 1502 provides information about the date of the wedding and the registry close date. Window 1500 shows the number of items in the gift registry. For this example, the appliance gift pictorial 1504 and the car down payment pictorial 1506 are shown for simplicity. The user will click on one of the gift pictorials and be taken to FIG. 16 window 1600 which shows the car down payment pictorial 1602. The total amount of the gift value is shown as $1000 [1604]. The user has segmented the gift into six parts to make each part more affordable to the guest. The guest has the option of purchasing one or more pieces of the puzzle at $166.67 each or purchasing all of them for $1000. By moving the curser over each puzzle piece the system will tell the guest whether or not the puzzle piece has been purchased. If the piece turns red 1606 it is available for purchase. If the piece turns grey 1608 it is not available for purchase. The guest selects a puzzle piece clicking on it and then it will turn green 1610. The guest can click the BUY GIFT button 1612 and purchase the puzzle piece or the guest can cancel (BUTTON 1614) this gift selection and select another gift.

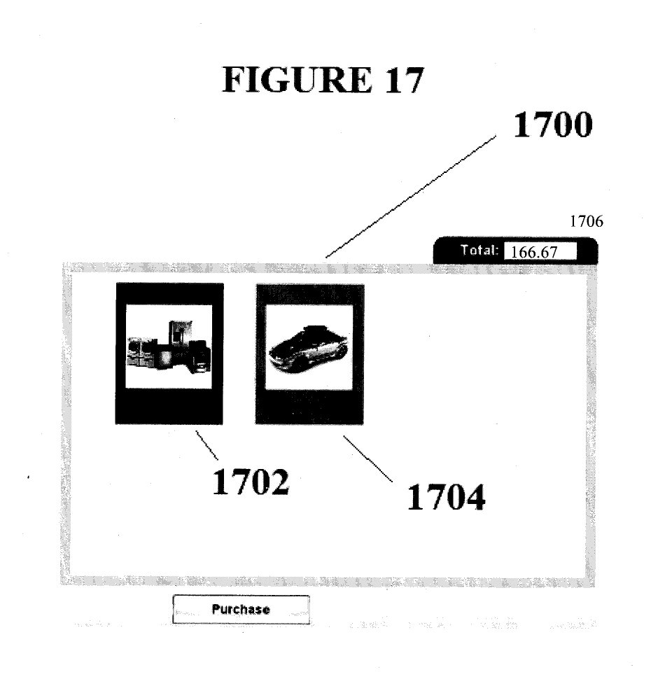

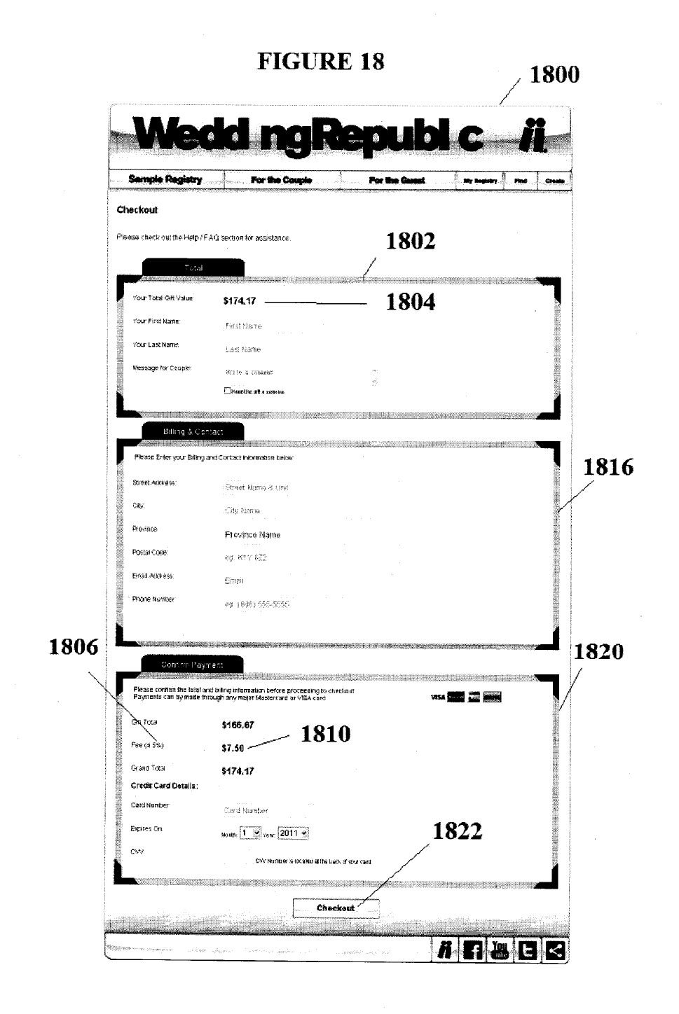

Once the guest clicks the BUY GIFT button 1612 the guest is taken to FIG. 17, window 1700 for purchase processing by an e-commerce application. The gifts selected 1702 and 1704 are placed in the purchase window 1700. The price of the gift is displayed in the price tab 1706. The guest will click the purchase button 1708 and be taken to FIG. 18, window 1800. In the “Total” window 1802, the total cost of the purchase is displayed 1804. Note that the system will add a system user fee 1810 to each purchase which is a percentage of the purchase price. In this example the user fee is 4.5% of each purchase price or $7.50 [1806] added to this purchase. The purchase of the gift is accomplished through known e-commerce methods over a social network wherein the guest will enter billing date in window 1816 and credit card data in window 1820. Once that is done, the guest will click the CHECKOUT button 1822. Once this is done, the payment is processed and the guest will receive confirmation that the purchase has been completed. The system will update the gift registry and notify the user of the purchase. As well, each gift can readily see from the gift registry which gifts have been purchased and which gifts still require a purchase. In this manner, the user and the guests are able to track the progress of the community of guests in achieving the community objective.

The user, in monitoring the progress of the community in achieving the objectives may notice that certain objectives are not being achieved. For example, it may be that a particular gift is not popular with guests but highly desirable for the user. The user can modify the gift registry and amend the priority data of the gift from a medium desirability to a high desirability. For example, the user may notice that no guest has purchased a toaster. The user can re-enter the gift registry and amend the customization of the toaster gift by increasing the priority of the toaster gift to three hearts or by segmenting the gift into a puzzle so that the per piece cost is much less than the total cost of the toaster.

Application #2

This invention is also well suited for the monitoring and tracking of community progress towards achieving a particular charitable objective, as in a fundraiser's request of a community to purchase “steps” in order to meet the objective of raising money for a Marathon runner.

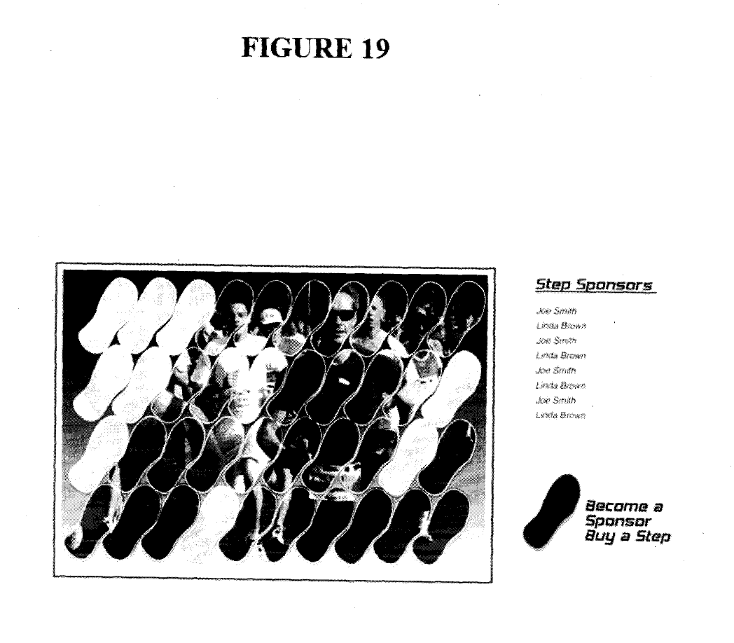

The process for a centralized online fundraising event is similar to that of a wedding registry previously described. The user provides registration information for a fund-raising organization. The user describes the event, chooses an amount to raise for the event, and uploading a picture that represents the fundraiser into the system. The user can segment contributions into multiple pieces that represent the event, in this example “steps”, allowing the fundraiser to engage multiple donors on one event, as illustrated in FIG. 19. The system will calculate the optimal price for an event piece based on the fundraiser's selection of number of steps.

The user relies on the system to share information and notify community members (i.e. friends, family, potential donors) about the event and the desired contributions. A user will have the ability to share their event with their social group through social networks such as Facebook or e-mail addresses which have been uploaded into the system. The system will track the community response across to the event to by monitoring each contributors purchase and visually representing this contributed advancement towards achieving the objective (i.e. donating to the event in its entirety).

When a charitable event has been updated by the fundraiser, the fundraiser's social group is updated through the fundraiser's social network and/or e-mail services. When a social group has completed one of the fundraiser's objectives (completed a donation towards an event item), the fundraiser's social group is updated through the fundraiser's social network and/or e-mail services. Contributions are made over social networks using e-commerce applications.

A donor can browse the event and has the ability to purchase one of more event segments. The guest can, if desired, purchase all segments of an event, therefore, purchase the entire event. Once the guest has selected the event segment or segments, they will finalize their contribution towards achieving the ultimate charitable objective.

Payment of a contribution follows the process for payment of a gift previously described.

The invention provides the following advantages for a fundraising charity:
A centralized online event registry that provides registration of information for an event fundraiser and allows access to the event registry to a group of potential donors.
The ability to create new fundraising events or customize existing event by modifying/adding a description, choosing a price for the event, and uploading a picture that represents the event.
A distinct advantage of this system is that a registrant can segment an event into multiple, allowing the fundraiser to engage multiple donors on one event. With more people able to chip in, larger charitable objectives become more accessible to the fundraiser.
Fundraisers can reach broad audience of donors through social media; the system allows for easy dissemination from one donor who wishes to share the charitable objective within their social network
Fundraisers can add a visual representation of virtually anything, making the message associated with the charitable event flexible (a picture of a marathon runner or a logo of a charitable organization).
The visual representation provides clear and measurable action steps that community members can take to fulfill the objective and allows the donors to see what they are contributing to.
Fundraisers can easily track how much of the event has been purchased and monitor whether they need to create additional event items.
System for monitoring progress allows the fundraiser to evaluate community response and apply the knowledge as needed.
Contributors can contribute over social networking using e-commerce applications.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A system for a user to select a common community objective and for a community of individuals to contribute to said common community objective, said system comprising:
a. a communications network for said user to communicate with a computer system to create and disseminate the common objective to said community of individuals;
b. a social network permitting each individual of the community of individuals to communicate with said computer system and contribute to the common objective using an e-commerce application; and,
c. the computer system comprising a user terminal, a terminal accessible by each individual of the community of individuals, a user database for storing a plurality of community objectives, a data registry within said database for storing a set of user selected community objectives, a microprocessor connected to said database for operating the computer system, an Internet server for conveying and displaying said set of user selected common objectives to the community of individuals, an e-commerce payment system linked to said social network and operable over the social network thereby permitting each individual of the community of individuals to contribute to the objective, and a feedback system that permits the user and the community of individuals to monitor and measure the progress of the community in achieving the user selected objectives.

2. The system of claim 1 wherein the user selected objective is a cash objective.

3. The system of claim 2 wherein the user selected objective comprises a plurality of user selected sub-objectives.

4. The system of claim 3 wherein said plurality of user selected sub-objectives are selected from said user database.

5. The system of claim 4 wherein the user populates the data registry of with the plurality of selected sub-objectives.

6. The system of claim 5 wherein the data registry of selected sub-objectives is published on said system Internet server for viewing by the community of individuals.

7. The system of claim 6 wherein each selected sub-objective on the published data registry is assigned a cash value so that the aggregate of sub-objective cash values equals said cash objective.

8. The system of claim 7 wherein said e-commerce payment system is used by the individual to contribute said cash value to at least one selected sub-objective over the social network.

9. The system of claim 8 wherein said feedback system comprises purchase records of each sub-objective selected by an individual, a tag placed on the selected sub-objective indicating an unavailable status, so that the user can, upon demand, obtain a tally of said purchase records and a tally of selected and unselected sub-objectives on the data register.

10. The system of claim 3 further comprising user means to prioritize each sub-objective of said plurality of selected sub-objectives so that an individual may contribute to the sub-objective with the highest priority.

11. The system of claim 2, further comprising user means to segment said cash value into a predetermined number of smaller equal sums.

12. The system of claim 1 wherein said social network comprises at least one of the following: FACEBOOK, TWITTER, AIMSHARE, BEBO, BLOGGER, CURRENT, DIG, FARK, BLINKLIST, E-MAIL, DELICIOUS, CARE2, FAVES, BLOGMARKS, FORMSPRING, ADDTOBX, DIGO, TEXT and DEALSPLUS.

13. A method for using a computer system connected to a computer network and a social network for a user to establish a common community objective and to facilitate contributions by a community of individuals to said common community objective comprising the following steps by said user:
a. selecting a common community objective;
b. segmenting said common community objective into a number of sub-objectives;
c. assigning a pictorial representation to each of said number of sub-objectives;
d. selecting said number of sub-objectives from a system database storing a plurality of selectable sub-objectives;
e. assigning a cash value to each selected sub-objective;
f. populating a first data registry with said pictorially represented number of cash valued sub-objectives;
g. storing said populated first data registry on said system database; and,
h. publishing the first data registry with a unique URL on said computer network for access by said community of individuals.

14. The method of claim 13 wherein the step of assigning a cash value to each selected sub-objective further includes the step of segmenting the cash value into cash value fractions and displaying said cash value fractions as a puzzle matrix over the pictorial representation of each selected sub-objective.

15. The method of claim 13 further comprising the user step of assigning a priority to each sub-objective in order of desirability so that a community individual is able to determine which sub-objectives are most desirable to the user.

16. The method of claim 15 further comprising the step of representing said sub-objective priority visually on the associated sub-objective pictorial representation.

17. The method of claim 13 wherein the step of selecting the number of sub-objectives from said system database includes the system user uploading a personalized sub-objective to the system database.

18. The method of claim 13 further comprising the user steps of:
a. creating a second data registry comprising the e-mail address of each individual in the community of individuals;
b. storing said second data registry on said system database; and,
c. notifying each individual by e-mail over the computer network of said unique URL.

19. The method of claim 14 further comprising the community individual steps of:
a. accessing the first data registry over said social network;
b. selecting a cash valued sub-objective for a contribution;
c. placing said selected cash valued sub-objective in a system payment window; and,
d. using a system e-commerce system over the social network to make a cash contribution equal to the cash value of said sub-objective.

20. The method of claim 13 further comprising a feedback process comprising the following system steps:
a. recording on the database a contribution to a cash valued sub-objective;
b. marking said contributed sub-objective as unavailable for further contribution;
c. updating the published first data registry to indicate remaining available sub-objectives;
d. providing upon request by the user a tally of available and unavailable sub-objectives.
e. identifying a sub-objective having a low priority;
f. altering the visible priority rating on said low priority sub-objective to a higher priority; and,
g. republishing the first registry with a new set of prioritized sub-objectives.
